(19) United States
(12) Patent Application Publication
(10) Pub. No.: US 2013/0042704 A1
(43) Pub. Date: Feb. 21, 2013

(54) Sample Processing Apparatus

(71) Applicants: Donald Van Duyne, Metuchen, NJ (US); Eric Gold, Metuchen, NJ (US); John Martin, Easton, PA (US)

(72) Inventors: Donald Van Duyne, Metuchen, NJ (US); Eric Gold, Metuchen, NJ (US); John Martin, Easton, PA (US)

(21) Appl. No.: 13/211,850

(22) Filed: Aug. 17, 2011

(51) Int. Cl. B01L 3/00

(52) U.S. Cl. 73/864.91

(57) ABSTRACT

A machine which has a platform for a specimen container and is constructed to spin the platform to produce centrifugation of the specimen is provided with a linkage that can selectively convert the spinning to a more complex form of motion effective to produce disruption of the specimen on the platform. Preferably, the linkage causes tilting of the platform about the axis of spinning, thereby providing a conical form of motion. In a preferred embodiment, the linkage is constructed to provide the complex motion when the platform is rotated in one direction and to provide spinning when the platform is rotated in the opposite direction.

### BACKGROUND OF THE INVENTION

The present invention relates generally to an apparatus for processing samples, such as chemical and biological samples, and, more particularly, concerns such an apparatus which can perform disruption as well as centrifugation.

Today, chemical and biological samples are typically prepared in titer plates or individual vials. An extracting solvent or buffer may be added, if needed, and the samples are then shaken, either manually or by means of a mechanical disrupter, homogenizer, shaker, agitator, or vortexer (hereafter referred to generically as a “disrupter”). Thereafter, the samples are removed from the mechanical device and transferred to a centrifuge, where they are spun high speed to effect separation. This includes, but is not limited to separation of solids from liquids, separation of liquids of different density, and collection of DNA or RNA.

Since disruption and centrifugation involve two different pieces of equipment, the operator must manually transfer the sample containers from one piece of equipment to the other. This requires him to be present for both steps and requires time and effort to transfer samples and start the operation of the second piece of equipment. The skill and time of the operator could be utilized in much more meaningful and profitable ways.

It is therefore an object of the present invention to provide a sample processing apparatus which can perform both disruption and centrifugation of samples. It is specifically an object of the invention that the apparatus be capable of transitioning between disruption and centrifugation modes of operation automatically and with minimal operator intervention, other than to select the mode of operation, and without the operator handling samples, other than to insert or remove them from the apparatus. It is specifically contemplated that the operator should not be required to achieve a change in the mode of operation of the apparatus.

It is yet another object of the invention to provide a sample processing apparatus which is reliable in construction, yet relatively easy and convenient to use.

In accordance with one aspect of the present invention, a machine which has a platform for specimen container and which is constructed to spin the platform to produce centrifugation of the specimen is provided with a linkage that can selectively convert the spinning to a more complex form of motion effective to produce disruption of the specimen on the platform. Preferably, the linkage causes tilting of the platform relative to the axis of spinning, thereby providing a conical motion of the platform central axis and a complex, oscillatory motion of the samples. In a preferred embodiment, the linkage is constructed to provide the complex motion when the drive mechanism is rotated in one direction and to provide spinning of the platform when the drive mechanism is later rotated in the opposite direction.

### BRIEF DESCRIPTION OF THE DRAWINGS

The foregoing brief description and further objects, features and advantages of the present invention will be understood more completely from the following detailed description of the presently preferred, but nonetheless illustrative embodiment in accordance with the present invention, with reference being had to the accompanying drawings in which:

FIGS. 1-5 are simplified perspective views illustrating the operation of a processing apparatus 10 embodying the present invention;

FIG. 6 is a simplified perspective view of apparatus 10, with the two offsets 16 and 18 cut away to show interior details; and

FIG. 7 is a simplified perspective view, similar to FIG. 6, with offset 16 removed.

### DETAILED DESCRIPTION

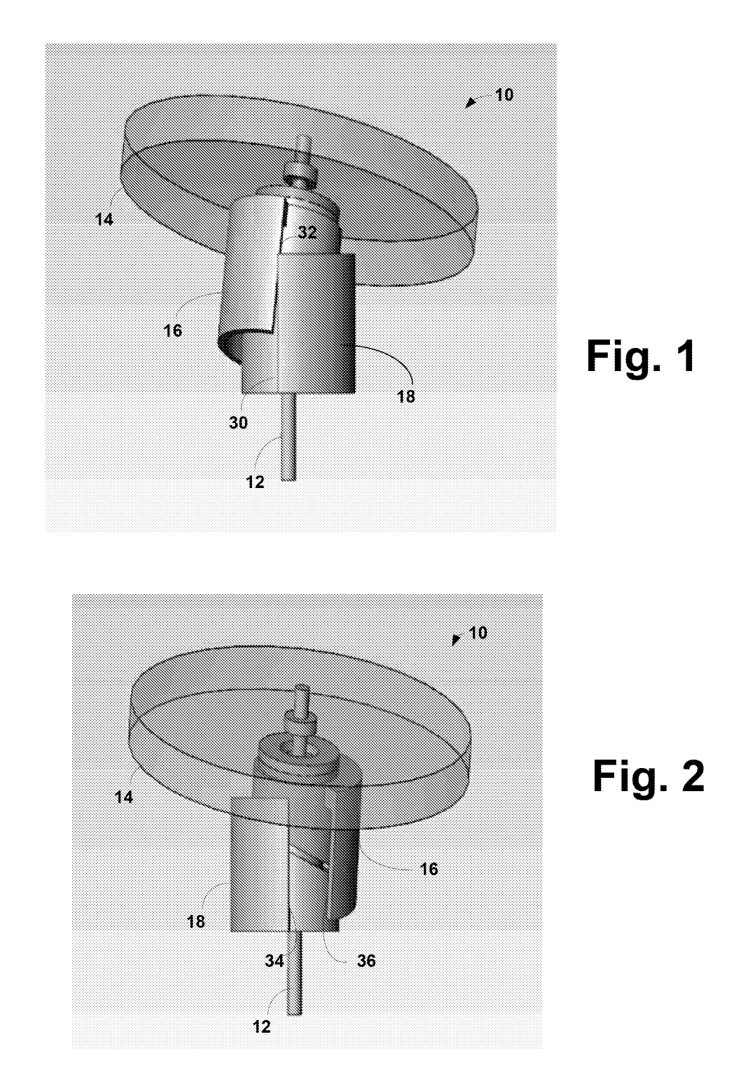

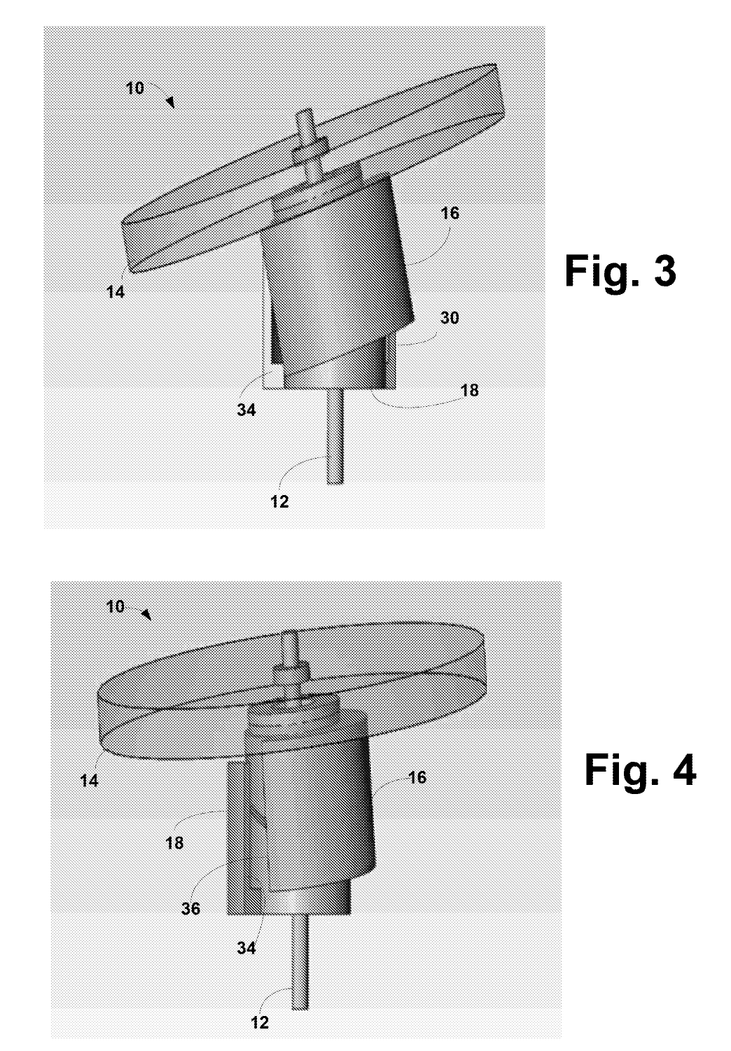

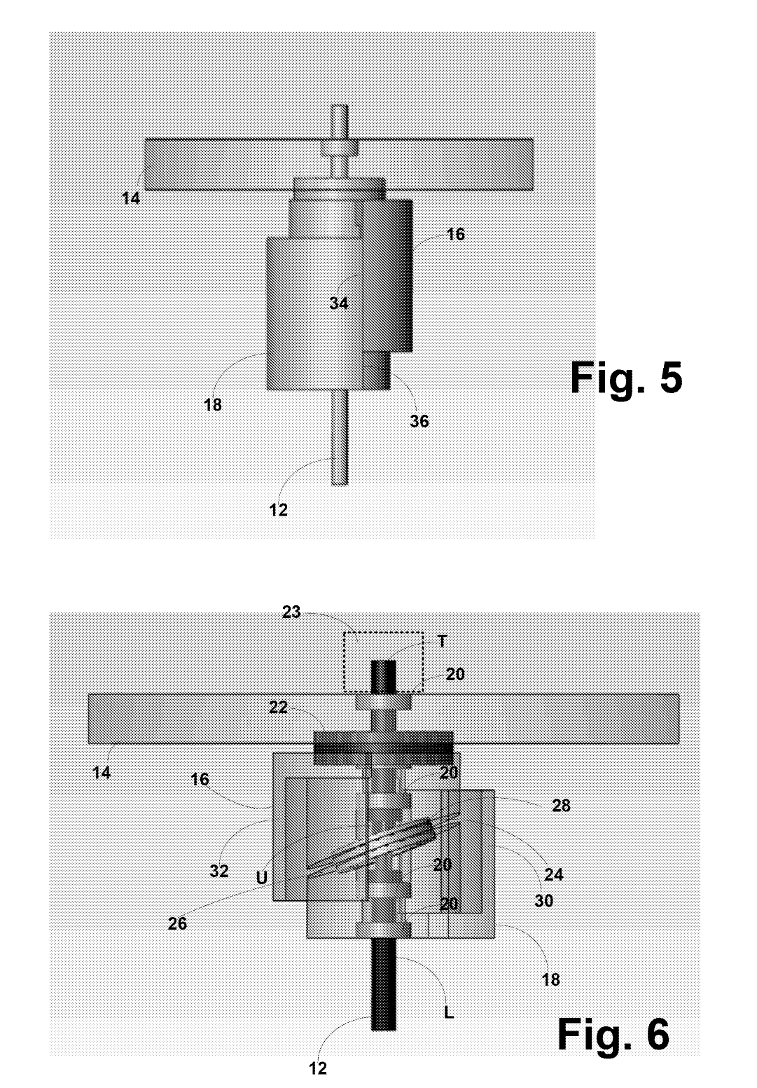

FIGS. 1-5 are perspective views illustrating the operation of a processing apparatus 10 embodying the present invention. Apparatus 10 has two modes of operation, being capable of performing as both a disrupter (FIG. 1) and a centrifuge (FIG. 5). A container containing the sample (not shown) is mounted on a sample plate 14, which is mounted on a top offset 16, which is, in turn, mounted on a bottom offset 18. Sample plate 14, top offset 16, and bottom offset 18 are all mounted for rotation about a shaft 12.

The mode of operation will depend upon the direction of movement of sample plate 14. A motor drive, for example via a pulley (not shown), is applied to bottom offset 18. In order to enter the disrupter mode, bottom offset 18 is rotated counterclockwise. As will be explained in more detail below, counterclockwise movement of bottom offset 18 relative to top offset 16 produces an interaction between the two offsets which causes the offset 16, sample plate 14 a sprag clutch 22 (discussed further below), and an upper portion of shaft 12 to tilt, as a unit, relative to offset 18 and a lower portion of shaft 12 (compare FIGS. 1 and 5). Sample plate 14 and offsets 16 and 18 then rotate counterclockwise, as a unit, about shaft 12. This tilted rotation of sample plate 14, which has an oscillatory component to it as well, produces complex, oscillatory movement and disruption of the sample.

When disruption is complete, the motor drive of bottom offset 18 is slowed and then reversed, so that it rotates clockwise. Clockwise rotation of offset 18 relative to offset 16, through their interaction, then brings the two offsets and sample plate 14 into axial alignment with shaft 12 (see FIG. 5). Rotation of bottom offset 18 about shaft 12 can then be accelerated, bringing sample plate 14 up to a rotational speed at which apparatus 10 will function as a centrifuge.

Those skilled in the art will appreciate that the transition between disrupter and centrifuge modes of operation could simply be accomplished through operator manipulation of controls. However, it is well within the skill of the art to incorporate automatic control, including timers, which can be preset to desired durations for disruption and centrifugation. Of course, automatic control also allows presetting of operating speeds, acceleration, and other operating parameters.

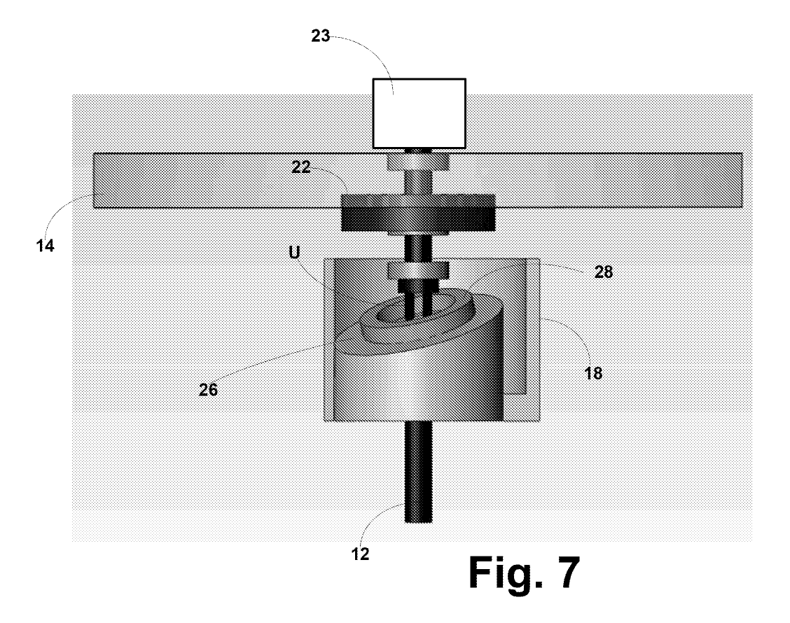

FIG. 6 is a perspective view of apparatus 10, with the two offsets 16 and 18 cut away to show interior details, and FIG. 7 is a perspective view, similar to FIG. 6, with offset 16 removed. As may be seen, shaft 12 is made up of a lower shaft L and a top shaft T, which are joined by a universal joint U. Bearings 20 are provided to permit free rotation of sample plate 14 and offsets 16 and 18 relative to shaft 12.

A sprag clutch 22 is provided between sample plate 14 and top offset 16, which holds sample plate 14 to shaft 12, while permitting free rotation about top offset 16, during disruption (counterclockwise rotation of offset 18). At the same time, a sprag cover 23 mounted on shaft 12 above platform 14 holds the platform to sprag clutch 22. This results in transfer of the complex motion to sample plate 14 with it not rotating about shaft 12. When apparatus 10 switches modes (clockwise rotation of offset 18 transferred to offset 16) clutch 22 permits free clockwise rotation of top offset 16 and holds it to sample plate 14, transferring rotational motion to sample plate 14.

Top offset 16 and bottom offset 18 have opposed surfaces 24, 26, which are formed at an acute angle to the axis of shaft 12. That is, they are not in a plane perpendicular to the axis of shaft 12. A bearing 28 permits relative rotation of offsets 16, 18 about an axis perpendicular to surfaces 24, 26.

In operation, when bottom offset 18 is driven counterclockwise, it will rotate relative to top offset 16 about the shaft 12 until its most counterclockwise edge 30 comes into contact with the most clockwise edge 32 of top offset 16. As bottom offset 18 rotates counterclockwise relative to top offset 16, top offset 16 also rotates about bearing 28 and begins to tilt, carrying sample plate 14 with it. When edges 30 and 32, come into contact, bottom offset 18 pushes tilted top offset 16, driving sample plate 14 in a conical pattern. As can be seen in FIG. 2 (showing the opposite side of apparatus 10), at this time, the most clockwise edge 34 of bottom offset 18 and most counterclockwise edge 36 of the top offset 16 are far apart.

Later, when bottom of offset 18 is driven clockwise, edge 34 moves towards edge 36 (see FIG. 4), and the movement causes top offset 16 to rotate about bearing 28 towards an upright position, causing the axis of sample plate 14 to shift towards alignment with the axis of shaft 12. When edges 34 and 36 come into contact (see FIG. 5), the axes of sample plate 14 and shaft 12 are in alignment, and bottom offset 18 pushes top offset 16 into clockwise rotation. Through the action of sprag clutch 22, sample plate 14 is also brought into clockwise rotation, enabling centrifuge operation.

When centrifugation is complete, the sample can be removed by the operator and replaced with a new sample, which can be subjected to both disruption and centrifugation.

While the example shown herein uses a linkage to impart a first type of motion in one direction and a second type of motion in the other direction, the direction of rotation need not change. Instead, the change in type of motion can occur even if rotation is in the same direction for both types of motion. In this case, the additional linkage causing the more complex type of motion might take a different form or be eliminated.

Generally, the disruption motion desired in the preferred embodiment is an oscillatory tilting of the axis of rotation of the sample plate, coupled with rotation of the tilted axis. In the centrifuge mode, the sample plate is to be rotated about the axis of rotation. By switching between these modes after a predetermined time, or after a parameter indicative of sample disruption has occurred, both required processes can be performed in the same apparatus without having to change samples and/or vessels.

Rather than switch the type of motion after a predetermined time, other parameters indicative of the completion of the disruption or other first mode of motion can be used. For example, the system could measure the number of cycles of motion executed during the first mode, or could include a detector to determine when the proper amount of separation or disruption has been achieved. Any parameter sufficient to indicate when the first mode is complete may be used instead of a timer. Moreover, the switch between the two types of motion could be manual, as an operator may wish to activate such switch based upon a visual inspection of the sample as it undergoes the processing via the first type of motion.

Although a preferred embodiment of the invention has been disclosed for illustrative purposes, those skilled in the art will appreciate that many additions, modifications, and substitutions are possible without departing from the scope and spirit of the invention as defined by the accompanying claims. For example, a variety of gearing and bearing arrangement may be used to alter the type of motion imparted on the sample.

What is claimed:

1. A sample processing apparatus comprising:
a platform for receiving a sample in a container;
a driver providing spinning motion to the platform, about a spinning axis, sufficient to produce centrifugation of the sample; and
a linkage interposed between the driver and the platform and constructed to selectively convert the spinning motion to a more complex movement effective to cause disruption of the sample.

2. The sample processing apparatus of claim 1 wherein the linkage is constructed to tilt the platform relative to the spinning axis so as to impart a conical motion to the platform.

3. The sample processing apparatus of claim 2 wherein the linkage comprises:
means mounting the driver and platform for rotation about the spinning axis;
an intermediate member interposed between the driver and the platform mounted for rotational movement about the axis of spin;
opposed faces on the driver and intermediate means lying in a plane which is inclined relative to the axis of spin;
means in the vicinity of the opposed faces for rotational motion about an axis perpendicular to the inclined plane, whereby the intermediate member may be tilted relative to the axis of spin through relative rotation between the driver and the intermediate member.

4. The sample processing apparatus of claim 3 wherein the platform, the intermediate member and the driver are all mounted for rotation on a shaft, the shaft having a flexible joint in the vicinity of the opposed faces.

5. The sample processing apparatus of claim 3, further comprising:
first stop means preventing further relative rotation between the driver and the intermediate member in a first rotational direction after they have achieved a coaxial relationship;
second stop means preventing further relative rotation between the driver and the intermediate member in a second rotational direction, opposite to the first rotational direction, after the intermediate member has achieved a predetermined tilt relative to the axis of spin.

6. The sample processing apparatus of claim 5 wherein the platform, the intermediate member and the driver are all mounted for rotation on a shaft, the shaft having a flexible joint in the vicinity of the opposed faces.

7. The sample processing apparatus of claim 5, further comprising means preventing said intermediate member from rotating relative to the platform in the first rotational direction.

8. The sample processing apparatus of claim 7 wherein the platform, the intermediate member and the driver are all mounted for rotation on a shaft, the shaft having a flexible joint in the vicinity of the opposed faces.

9. The sample processing apparatus of claim 2 wherein the linkage is constructed to produce said tilt when the platform is rotated in one direction and to produce spinning when the platform is rotated in the opposite direction.

10. The sample processing apparatus of claim 1 wherein the linkage is constructed to convert to said complex motion when the platform is rotated in one direction and to produce spinning when the platform is rotated in the opposite direction.

11. The sample processing apparatus of claim 10 wherein the linkage comprises:
means mounting the driver and platform for rotation about the spinning axis;
an intermediate member interposed between the driver and the platform mounted for rotational movement about the axis of spin;
opposed faces on the driver and intermediate means lying in a plane which is inclined relative to the axis of spin;
means in the vicinity of the opposed faces for rotational motion about an axis perpendicular to the inclined plane, whereby the intermediate member may be tilted relative to the axis of spin through relative rotation between the driver and the intermediate member.

12. The sample processing apparatus of claim 11 wherein the platform, the intermediate member and the driver are all mounted for rotation on a shaft, the shaft having a flexible joint in the vicinity of the opposed faces.

13. The sample processing apparatus of claim 11, further comprising:
first stop means preventing further relative rotation between the driver and the intermediate member in a first rotational direction after they have achieved a coaxial relationship;
second stop means preventing further relative rotation between the driver and the intermediate member in a second rotational direction, opposite to the first rotational direction, after the intermediate member has achieved a predetermined tilt relative to the axis of spin.

14. The sample processing apparatus of claim 13 wherein the platform, the intermediate member and the driver are all mounted for rotation on a shaft, the shaft having a flexible joint in the vicinity of the opposed faces.

15. The sample processing apparatus of claim 13, further comprising means preventing said intermediate member from rotating relative to the platform in the first rotational direction.

16. The sample processing apparatus of claim 15 wherein the platform, the intermediate member and the driver are all mounted for rotation on a shaft, the shaft having a flexible joint in the vicinity of the opposed faces.

17. Apparatus comprising a sample plate connected to a rotation shaft for causing rotation of the sample plate about an axis of rotation, and at least one bearing or linkage for imparting on said sample plate an oscillatory tilting motion, and a control system for causing the oscillatory tilting motion to switch to rotation upon a predetermined parameter indicating that a first mode of sample preparation is complete.

18. The apparatus of claim 17 wherein the predetermined parameter is either time or number of cycles.

19. The apparatus of claim 18 wherein rotation direction is altered when the oscillatory tilting motion changes to rotation.

20. Apparatus for sample preparation comprising at least one bearing for imparting a first type of motion upon a sample to disrupt said sample while spinning, and for imparting a second type of motion which does not cause further disruption of said sample, said first and second types of motion including spinning in opposite directions, with said first type of motion including tilting of an axis around which said sample spins.
